(19) United States
(12) Patent Application Publication
(10) Pub. No.: US 2017/0341460 A1
(43) Pub. Date: Nov. 30, 2017

(54) DEVICE AND METHOD FOR A HANDS-FREE TOOL HOLDER

(71) Applicant: Dillon R. Estes, Mason, TX (US)

(72) Inventor: Dillon R. Estes, Mason, TX (US)

(21) Appl. No.: 15/605,891

(22) Filed: May 25, 2017

Related U.S. Application Data
(60) Provisional application No. 62/341,443, filed on May 25, 2016.

(51) Int. Cl. B43L 15/00; B43K 23/004

(52) U.S. Cl. CPC B43L 15/00; B43K 23/004

(57) ABSTRACT

An apparatus and method to hold a tool is disclosed. In one embodiment, the tool holder comprises two elastic components. One elastic component fits around a finger and the second elastic component fits around the tool. In a more specific embodiment, the tool is a pen or pencil. A method is disclosed of attaching the device to a finger and a tool and using the device by moving the tool with one or more fingers that are adjacent to the finger with the attached tool.

### CROSS REFERENCE TO RELATED APPLICATION

The present application is a United States Non-Provisional Patent Application that claims priority to U.S. Provisional Patent Application Ser. No. 62/341443, filed May 25, 2016, which is incorporated in its entirety by reference.

### TECHNICAL FIELD

This invention relates to the field of tool holders. In one embodiment, this invention relates generally to a tool holder that does not require the use of hands to hold the tool. In a specific embodiment, this invention generally relates to hands-free stylus, pen or pencil holder attached to a finger.

### BACKGROUND

This section is intended to introduce the reader to various aspects of art, which may be associated with embodiments of the present invention. This discussion is believed to be helpful in providing the reader with information to facilitate a better understanding of particular techniques of the present invention. Accordingly, it should be understood that these statements are to be read in this light, and not necessarily as admissions of prior art.

Today, there are many common every day devices that requires consistent use of the hands. These devices, includes phones, books, computing devices, remotes and other items. It is desirable to have one or both hands relatively free, which is not the case if one must hold a tool such as, pencil or pen in one hand, to be immediately available to write notes, or make entries. Dropping an item such as, a paper and picking up the writing instrument and vice versa interferes with the train of thought, that can be easily forgotten, during a considerable number of tasks. In addition, dropping an item may lead to loss of that item and wasted time in finding or replacing that item.

U.S. Pat. No. 3,402,984 discloses a “holder for a pen or pencil comprising a resilient C clamp swivelly mounted on a sleeve adapted to be slid on a finger.” Similar devices have a strap going around the hand or wrist. These devices are big and bulky. Accordingly, there is a need for a lightweight and nonrestrictive device. In addition, there is a need for a flexible device that can be easily and comfortably worn while doing many different tasks and provides consistent access to an item or tool such as, writing instrument with simple movement (such as, a flick) of one or more finger. This invention satisfies that need.

### SUMMARY

In one embodiment, a device is disclosed. In this embodiment, the device comprises two connected elastic bands, a first elastic band sized for insertion of a finger and a second elastic band for securely holding a tool. The elastic bands can be connected by sewing one or more pieces of elastic material together.

In one embodiment, a method is disclosed. In this embodiment, the method comprises obtaining an elastic band comprising a first elastic opening sized for a finger and a second elastic opening sized for a tool, inserting a finger into the first elastic opening and inserting a tool in a second elastic opening.

### BRIEF DESCRIPTION OF THE DRAWINGS

The foregoing and other advantages of the present technique may become apparent upon reading the following detailed description and upon reference to the drawings in which:

FIG. 1 illustrates a prospective view of one embodiment of a finger tool holding device;

FIG. 2 illustrates a frontal view of one embodiment of a finger tool holding device;

FIG. 3 illustrates a side view of one embodiment of a finger tool holding device attached to pencil and an operator's finger during use of the tool.

### DESCRIPTION OF EMBODIMENTS

Below is a description of various embodiments of the invention. Before describing selected embodiments of the present disclosure in detail, it is to be understood that the present invention is not limited to the particular embodiments described herein. The disclosure and description herein is illustrative and explanatory of one or more presently preferred embodiments and variations thereof, and it will be appreciated by those skilled in the art that various changes in the design, organization, means of operation, structures and location, methodology, and use of mechanical equivalents may be made without departing from the spirit of the invention.

It should be understood that the drawings are intended to illustrate and plainly disclose presently preferred embodiments to one of skill in the art. The drawings are not intended to be manufacturing level drawings or renditions of final products and may include simplified conceptual views to facilitate understanding or explanation. In addition, the relative size and arrangement of the components may differ from that shown and still operate within the spirit of the invention.

Moreover, it should be understood that various directions such as “upper”, “lower”, “bottom”, “top”, “left”, “right”, “first”, “second” and so forth are made only with respect to explanation in conjunction with the drawings. The inventive components may be oriented differently, for instance, during transportation, manufacturing and operations. Numerous varying and different embodiments and modifications may be made within the scope of the concept(s) embodiments herein taught, and described. Therefore, it is to be understood that the details herein are to be interpreted as illustrative and non-limiting. For example, many embodiments and examples are used to describe the device for hold a pen or pencil. However, the invention can be used to handle most handheld tools. Examples of such tools include but are not limited to: paint brushes, crayons, flashlights, laser pointers, hair brushes, hairpins, combs, make-up, make-up applicators, rulers, pens, pencils, stylus, screwdrivers, hammers, keys, knifes, cutlery, nails, screws, scissors, wrenches, drill bits, file, pliers, sockets, bolts, caps, can openers, bottle openers, cork screws, mixers, thermometers, syringes, paperclips, pins, needles, string, yarn, selfie sticks, and phone accessories.

One embodiment of the invention is a device for holding and/or transporting an object, device or tool such as a, writing utensil without the use of hands. In a specific embodiment, the device is shaped like a figure eight.

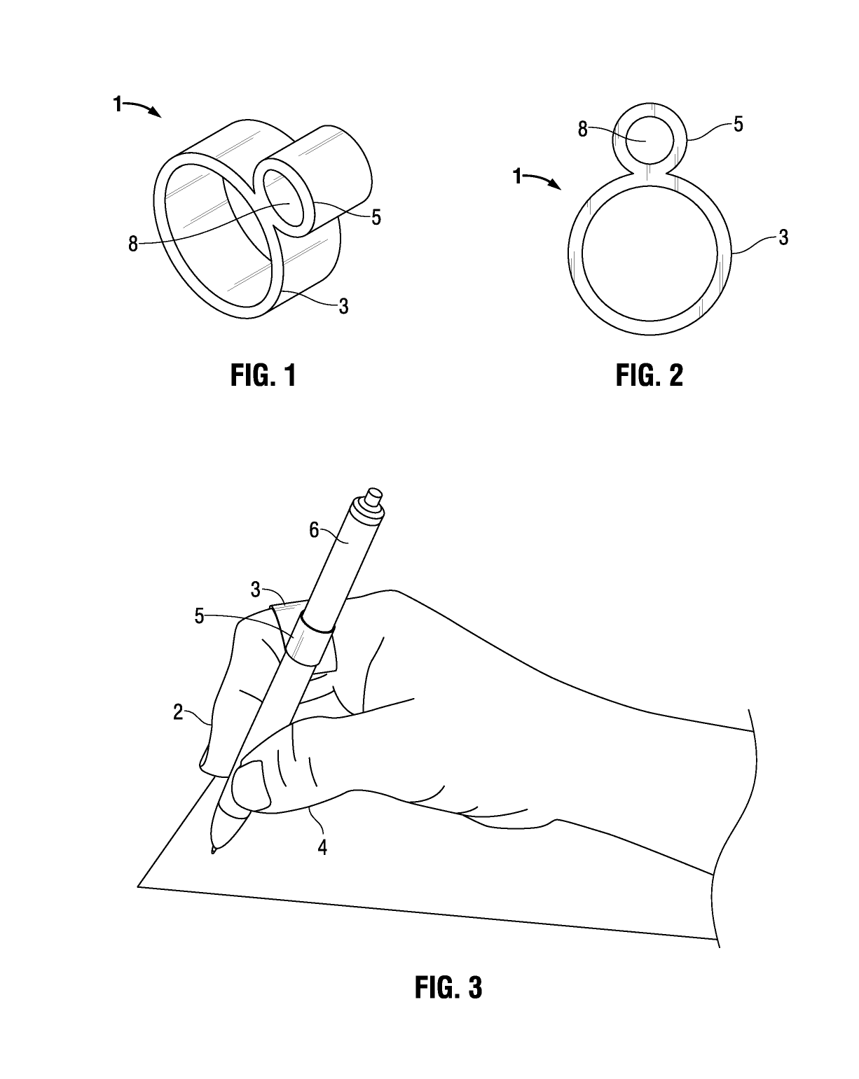

FIG. 1 is prospective view of the finger tool holding device. As shown in FIG. 1 the device 1 comprises two connected elastic bands. The first elastic band 3 is sized for insertion of a finger typically, the index finger (or pointer finger). The second elastic band 5 is sized for securely holding a tool in the region 8 inside elastic band 8. In the example shown in FIG. 1, the two bands are connected by having the materials sewn together. In addition, the bands can be connected by other means including but not limited to adhesives, rivets, staples, chemicals, melted materials, threads, fasteners, formed materials and combinations thereof.

In the example shown in FIG. 1, a half-inch wide soft braided elastic material called Dritz manufactured in Spartanburg, South Carolina was used. Examples of suitable elastic material include but are not limited to material selected from the group consisting of spandex, lycra, braided elastic, rubber knit elastic, vinyl, nylon, cotton, polyester, Velcro and any combinations thereof In the example shown in FIG. 1, this first loop is meant to be worn around a finger such as, an index finger and the other loop holds a tool (or writing instrument) which is positioned in front of an index (or other) finger when not in use. When ready to write something (or engage the object inside), an operator can use his thumb (or other finger) to grab the writing instrument and position it between two fingers such as, the thumb and forefinger and begin writing. This device allows the operator to work hands free, if desired, without losing control of the tool inside the device or material.

FIG. 2 is a frontal view of the device 1, as detailed and described with FIG. 1. The same elements in FIG. 2 from FIG. 1 have been given the same numerals.

In one embodiment, the hand free device can be manufactured from one piece (or solid strand) of elastic material. Alternative embodiments include a plurality of pieces (or strands) of material that are combined to create the hands-free tool holder device. In this embodiment, the instrument (or tool) loop can be made first from the solid strand to be approximately the diameter of chosen instrument (such as, pencil) and then the second loop is made to be approximately the size of a finger (such as, index finger). Preferably the elastic opening would be sized slightly smaller than the finger or object to be inserted to allow the elastic opening to stretch and securely hold the object or finger inside. In another embodiment, predetermined finger loop sizes of small, medium, and large are chosen with a diameter chosen to favorably fit most finger sizes. In addition, the devices can be manufactured in a plurality of colors and designs including combinations of colors and designs to make them more appealing to consumers and can be sold individually or in packages of three or more. Preferably, the packages would contain at least three and up to six varieties to either fit most fingers or to allow most hand-held tool sizes to be used. For example, six different sizes would allow small, medium and large finger sizes as well as small tools (such as, pens) and larger tools (such, a ruler) in one package. The device is intended to be sold under the tradename Never Set™ and possibly under additional tradenames.

The band for the tool should have a diameter sized large enough to allow easy insertion of the tool but small enough to prevent the tool form falling out, marking someone or poking someone. Similarly, the loop for insertion of a finger should be large enough to allow easy insertion but small enough to securely wrap around the finger to prevent unwanted movement. The actual diameter will be influenced by the properties of the material or materials used including, but not limited to, the elastic properties of the materials. In one embodiment, the width of the loop is at least ⅛-inch wide and up to one-inch wide and the thickness of the material is no thicker than ⅛-inch thick.

The more the material stretches, the more securely the material can hold the object or tool and the larger the object can be. Preferably, the material and/or the elastic openings should stretch at least 10 percent, more preferably, should stretch at least 25 percent and most preferably, should stretch at least 50 percent. In most applications, the material and/or the elastic openings should not stretch more than 100 percent to prevent the tool form easily falling out of the material. Preferably, the elastic material should substantially return to the original form within at least one second of releasing the force causing the expansion.

A company logo or message such as, a warning could be included with the device by having it manufactured onto the original material or printed or sewn onto the device, as needed. This would allow for additional safety and marketing features of the device.

### Method:

In an embodiment, a method enables an operator to quickly position and release the tool through the movement of only one finger. In this embodiment, an elastic band comprising a first elastic opening sized for a finger and a second elastic opening sized for a tool is first obtained A finger can then be inserted into the first elastic opening and a tool is inserted into a second elastic opening. The insertion of the finger or tool can be in any order or reversed depending on the situation. At any time, the operator can engage the tool by moving at least one finger on the tool and sliding the tool between two fingers. The elastic material enables the tool to be quickly and easily moved from between the thumb to be above the index finger to allow the operator to use the tool, as needed. At any time, the operator can release the tool by moving at least one finger away from the tool and moving the tool above at least one finger. The elastic material will enable the operator to easily slide the tool above the finger to allow substantially unobstructed use of the hands and fingers.

FIG. 3 illustrates the device 1 from FIG. 1 with an index finger 2 from an operator inserted into the first loop 3 and the tool (pencil) 6 inserted into the second loop 5. As shown in FIG. 3, the pencil 6 is being used by being moved between the index finger 2 and the thumb 4 of the operator. When the pencil 6 is not needed, the pencil can be moved by a finger away from the hand to be above the index finger 2. The elastic material allows easy maneuvering of the tool and will slide and flex when needed without providing too much movement to lose contact with the index finger 2 and tool 6. Preferably, the elastic material will allow movement of the tool or object inside in all directions including the X, Y and Z axis.

### Benefits:

There are many benefits to this device. The benefits of the various embodiments of this device include but are not limited to saving time by not searching for a tool or stopping to set down a tool or pick up a tool; improved job productivity; efficiency—including saving time and money; profit margins increased from job productivity increases; reusable and thus, environmentally friendly; affordable; durable; easily assessable; interchangeable with different writing instruments and small hand tools; and the attractiveness of the small and sleek design. In one embodiment, this device can be used as an aid for people with disabilities including physical, mental and developmental disabilities. This device can also be used to comply with Americans with Disabilities Act (ADA) laws and regulations or address compliance issues. This device can be worn while doing many different tasks while providing constant access to a tool in a comfortable and secure manner.

I claim:

1) A device comprising:
a. two connected elastic bands;
b. a first elastic band sized for insertion of a finger; and
c. a second elastic band that is connected to the first elastic band wherein the second elastic band is sized for securely holding a tool.

2) The device of claim 1, wherein the first elastic band and the second elastic band are connected with sewing stitches.

3) The device of claim 1, wherein the first elastic band is larger than the second elastic band.

4) The device of claim 1, wherein the device comprises the two connected elastic bands shaped into a figure eight.

5) The device of claim 1, wherein the material comprising the device consists of one elastic band sewn together into two loops forming a figure eight shape to create the first elastic band connected to the second elastic band.

6) The device of claim 1, wherein the material is selected from the group consisting of spandex, lycra, braided elastic, knit elastic, vinyl, cotton, polyester, rubber, nylon, Velcro and any combinations thereof.

7) The device of claim 1, wherein the first elastic band and the second elastic band is at least ⅛-inch wide and no more than 1-inch wide.

8) The device of claim 1, wherein the first elastic band and the second elastic band is no more than ⅛-inch thick.

9) The device of claim 1, wherein the tool is chosen from the group consisting of pens, pencils, crayons, chalk, markers, paint brushes, handheld tools, and any combination thereof

10) The device of claim 1, further comprising a tool inserted into the second elastic band, wherein the tool can be moved in all directions while inside the second elastic band, wherein the tool is positioned above an index finger when the tool is not in use and the tool is positioned between a thumb and the index finger when being used.

11) A method comprising:
a. obtaining a device band comprising a first elastic opening sized for a finger and a second elastic opening sized for a tool;
b. inserting the finger into the first elastic opening; and
c. inserting the tool into the second elastic opening.

11) The method of claim 10, further comprising engaging the tool by moving at least one finger on the tool and sliding the tool between two fingers.

12) The method of claim 10, further comprising releasing the tool by moving at least one finger away from the tool and moving the tool above at least one finger.

13) The method of claim 10, wherein sewing stitches connect the first elastic opening and the second elastic opening.

14) The method of claim 10, wherein the first elastic opening is larger than the second elastic opening.

15) The method of claim 10, wherein the device comprises at least two elastic bands shaped into a figure eight.

16) The method of claim 10, wherein the device comprises one elastic band sewn together in two openings forming a figure 8 shape.

17) The method of claim 10, wherein the material comprising the device is selected from the group consisting of spandex, lycra, braided elastic, knit elastic, vinyl, cotton, polyester, Velcro and any combinations thereof

18) The method of claim 10, wherein the first elastic opening and the second elastic opening is at least ⅛-inch wide and no more than 1-inch wide.

19) The method of claim 10, wherein the first elastic opening and the second elastic opening is no more than ⅛-inch thick.

20). The method of claim 10, wherein an operator uses the tool and the operator of the tool is selected from the group consisting of students, teachers, waiters, businessmen, businesswomen, artists, musicians, construction workers, and any combinations thereof.
